(19) United States
(12) Patent Application Publication
(10) Pub. No.: US 2005/0255302 A1
(43) Pub. Date: Nov. 17, 2005

(54) Printed circuit board

(76) Inventor: Lien-Ming Yang, Chungli City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/930,212

(22) Filed: Aug. 31, 2004

(30) Foreign Application Priority Data
May 17, 2004 (TW) 93113819

(51) Int. Cl. B32B 3/00

(52) U.S. Cl. 428/209; 428/901

(57) ABSTRACT

A printed circuit board. The printed circuit board includes a patterned bottom layer, at least one core layer and one insulating layer laminated on the bottom layer. A correspondingly patterned conductive layer is on the patterned bottom layer, with the core layer and the insulating layer therebetween. The patterned conductive layer has a pattern similar to that of the patterned bottom layer, and the projection of the patterned conductive layer on the patterned bottom layer is equal to or within the pattern of the patterned bottom layer.

### BACKGROUND

The invention relates to a printed circuit board, and more particularly to a printed circuit board with less deformation when subject to heat.

Printed circuit boards (PCBs) are commonly used in various optoelectronic devices, such as liquid crystal displays (LCDs), wherein LCD cells are connected to PCBs with driving circuits to enable driving of active devices within the LCD cells.

FIG. 1 shows a conventional PCB 1. A core plate 30 of epoxy resin and glass fiber is provided as a supporting substrate. Conductive layers 20 and 21 are respectively formed on the upper and lower surface of the core plate 30. The conductive layers 20 and 21 comprise many circuits (not shown). Insulating interlayer resins 40 and 41 are formed on the conductive layers 20 and 21 providing to protection against short circuits. Conductive lines (not shown) are then formed in the insulating interlayer resins 40 and 41 to electrically connect the circuits of the conductive layers 20 and 21 with the sequentially formed pins 60, 61, and 62.

As shown in FIG. 1, when disposing a driving circuit on the PCB 1, pins 60, 61, 62 are first assigned on the PCB 1 for bonding the driving circuit (now shown) thereon. A metal bottom layer 7 is formed on the reverse side of the PCB 1 serving as EMI shielding.

The driving circuit is generally disposed on the periphery of an LCD panel. As the size of the LCD panel increases, the length of the PCB whereon the driving circuit mounted must be extended to adjust to the increased size.

As the length of PCB 1 extends, to fulfill demands for light weight, the gap size between pins 60, 61 and 62 must, however, be reduced, resulting in various problems due to misalignment.

Misalignment results from the expansion and contraction of the PCB 1. When subjected to heat, the various degree of thermal expansion of the front pins 60, 61 and 62 and the rear metal bottom layer 7 results in heavier thermal deformation of the PCB 1.

To resolve the described problems, multi-sectional PCBs are currently employed in large size panels to reduce thermal deformation by lessening the lengths thereof. Additionally, thicker PCBs are also employed, this method, however, increases costs.

### SUMMARY OF THE INVENTION

Accordingly, embodiments of the invention provide a PCB with less thermal deformation applicable for large panel displays.

Embodiments of the invention provide a printed circuit board, comprising a patterned bottom layer, at least one core layer and one insulating layer laminated on the bottom layer, and a correspondingly patterned conductive layer on the patterned bottom layer, with the core layer and the insulating layer disposed therebetween, wherein the patterned bottom layer has a pattern substantially the same as the correspondingly patterned conductive layer.

Embodiments of the invention additionally provide a printed circuit board, comprising a patterned bottom layer, at least one core layer and one insulating layer laminated on the bottom layer, and a correspondingly patterned conductive layer on the patterned bottom layer, with the core layer and the insulating layer disposed therebetween, wherein the patterned conductive layer has a pattern similar to that of the patterned bottom layer, and the projection of the patterned conductive layer on the patterned bottom layer is equal to or within the pattern of the patterned bottom layer.

By patterning the bottom layer to have a pattern substantially symmetrical to the pattern of conductive pin assignment, thermal expansion of the front and rear layer of the PCB is balanced, and provides sufficient EMI shielding.

The bottom layer is, for example, a first metal layer. The conductive layer is, for example, a second metal layer. The bottom layer and conductive layer comprise conductive materials with the same or similar thermal expansion coefficients, such as Cu, Au, Ag, Fe, W, Al, Ni, Co or their alloys.

The patterned bottom layer and conductive layer preferably have the same pattern. The insulating layer is, for example, a resin layer.

Solder mask is preferably disposed on the patterned conductive layer.

### DESCRIPTION OF THE DRAWINGS

The invention can be more fully understood by reading the subsequent detailed description and examples with references made to the accompanying drawings, wherein:

FIG. 1 illustrates a conventional PCB;

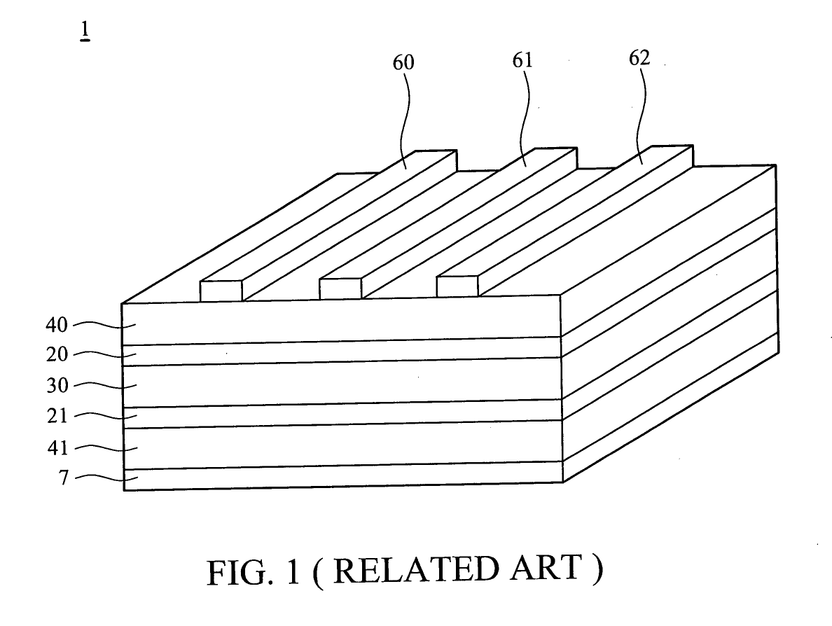

FIG. 2 illustrates the PCB of a first embodiment of the invention;

FIG. 3 illustrates the PCB of a second embodiment of the invention;

FIG. 4 is a cross-section of a first embodiment of the invention; and

FIG. 5 is a cross-section of a second embodiment of the invention.

### DETAILED DESCRIPTION OF THE INVENTION

One feature of embodiments of the PCB of the invention is the symmetrical pattern on the bottom layer and the conductive layer, by which the projection of the conductive layer on the bottom layer is equal to or within the pattern of the bottom layer. The PCB body and PCB manufacturing method are substantially the same as convention, and detailed descriptions thereof are thus omitted.

### First Embodiment

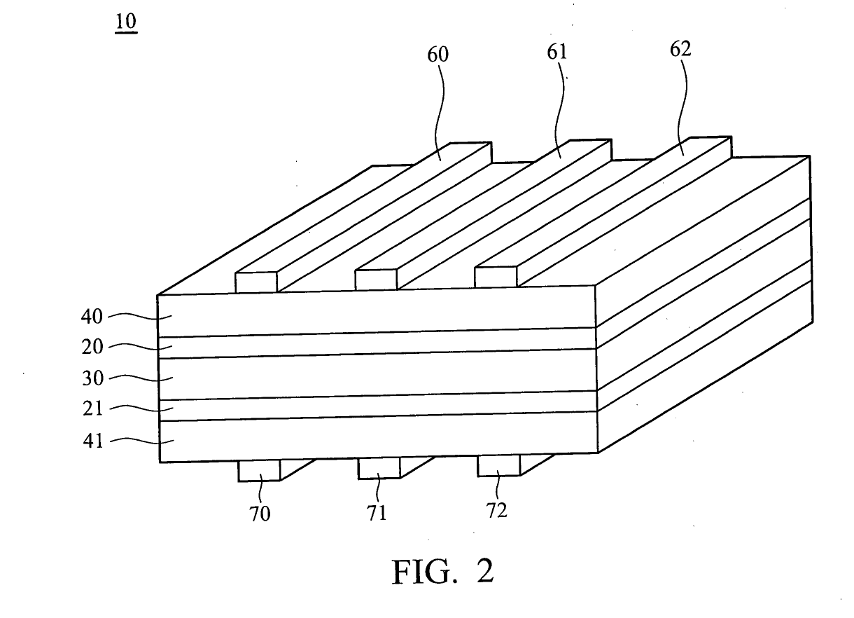

A multi-layered PCB 10, as shown in FIG. 2, is given hereby as description of the first embodiment.

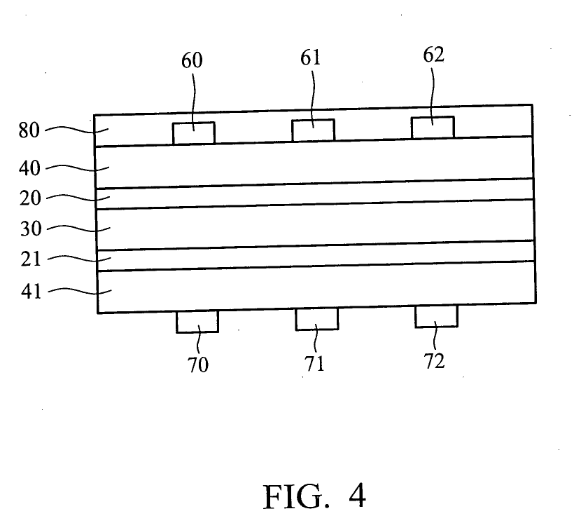

In FIG. 2, a core plate 30 comprises epoxy resin or glass fiber is provided as a supporting substrate for the multi-layered PCB 10. Conductive layers 20 and 21 are respectively formed on the upper and lower surface of the core plate 30. The conductive layers 20 and 21 comprise many circuits (not shown) serving as the so-called conductive pattern to provide electric connection among devices on and in the PCB 10. Insulating interlayer resins 40 and 41 are formed on the conductive layers 20 and 21 to protect against short circuits. Conductive lines (not shown) are then formed, by depositing and etching, in the insulating interlayer resins 40 and 41 to electrically connect the circuits of the conductive layers 20 and 21 with the sequentially formed conductive pattern (pins 60, 61, and 62). Finally, solder mask 80 is formed over the conductive pattern, as in FIG. 4, to insulate the conductive pattern. FIG. 4 is a cross-section of the PCB in FIG. 2, with an additional solder mask 80. In the embodiment, the conductive layers 20 and 21 comprise Cu. Meanwhile, the conductive layers 20 and 21 may be also comprise Au, Ag, Fe, W, Al, Ni, Co or their alloys. The insulating interlayer resins 40 and 41 comprise epoxy resins. Furthermore, as shown in the figures, the structure between the conductive layer and the bottom layer can be laminated multi-layers, comprising at least one core layer and one insulating layer.

The conductive pattern (60, 61, and 62) over the insulating interlayer resins 40 is designed for pin assignment. The basal pattern (70, 71, and 72) over the insulating interlayer resins 41, symmetrical and corresponding to the conductive pattern, is designed for pin assignment. The bottom layer (70, 71, and 72) can comprise the same or different materials as the conductive layer (60, 61, and 62), such as Cu, Au, Ag, Fe, W, Al, Ni, Co, or their alloys. The most common material is copper.

In the embodiment, no matter the basal pattern (70, 71 and 72) is bar or other shapes is all same with the the conductive pattern (60, 61 and 62). With perfect alignment of the basal pattern (70, 71 and 72) and the conductive pattern (60, 61 and 62), thermal expansion on the front and rear sides of the PCB 10 is balanced, protecting the PCB 10 from thermal deformation and providing sufficient EMI shielding.

### Embodiment 2

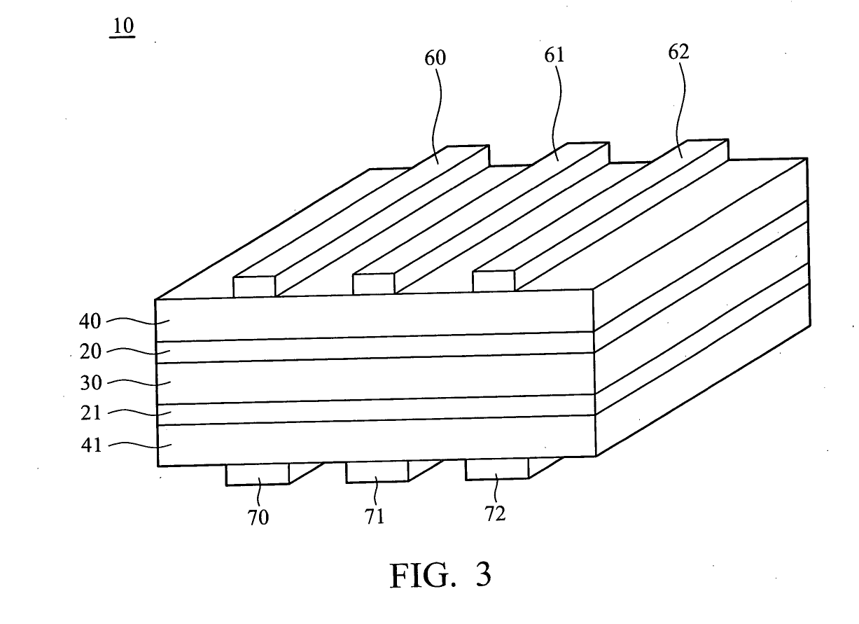

A multi-layered PCB 10, as shown in FIG. 3, is given hereby as description of the second embodiment.

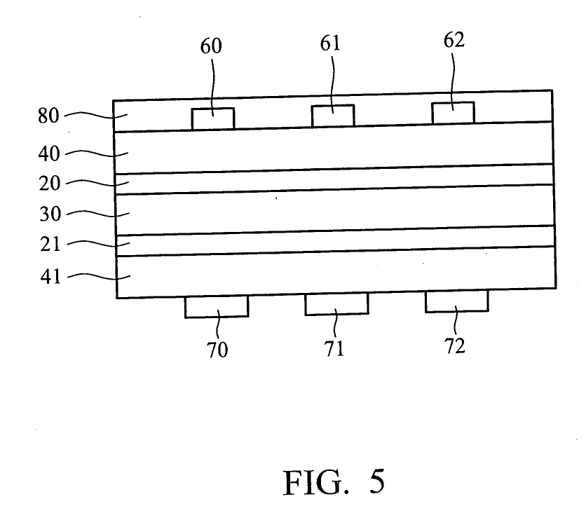

In FIG. 3, a core plate 30 of epoxy resin or glass fiber is provided as a supporting substrate of the multi-layered PCB 10. Conductive layers 20 and 21 are respectively formed on the upper and lower surface of the core plate 30. The conductive layers 20 and 21 comprise many circuits (not shown) as the so-called conductor pattern to provide electric connection among devices on and in the PCB 10. Insulating interlayer resins 40 and 41 are formed on the conductive layers 20 and 21 to protect against short circuit. Conductive lines (not shown) are then formed, by depositing and etching, in the insulating interlayer resins 40 and 40 to electrically connect the circuits of the conductive layers 20 and 21 with the sequentially formed conductive pattern (pins 60, 61, and 62). Finally, solder mask 80 is formed over the conductive pattern, as in FIG. 5, to ensure insulation of the conductive pattern. FIG. 5 is a cross-section of the PCB in FIG. 3, with an additional solder mask 80. In this embodiment, the conductive layers 20 and 21 comprise Cu. Meanwhile, the conductive layers 20 and 21 may be also comprise Au, Ag, Fe, W, Al, Ni, Co or their alloys. The insulating interlayer resins 40 and 41 comprise epoxy resins. Furthermore, as shown in the figures, the structure between the conductive layer and the bottom layer can be laminated multi-layers, comprising at least one core layer and one insulating layer.

This embodiment further features the conductive pattern (60, 61, and 62) over the insulating interlayer resins 40, designed for pin assignment. The basal pattern (70, 71, and 72) over the insulating interlayer resins 41, symmetrical and corresponding to the conductive pattern, is designed for pin assignment. The bottom layer (70, 71, and 72) can comprise the same or different materials as the conductive layer (60, 61, and 62), such as Cu, Au, Ag, Fe, W, Al, Ni, Co, or their alloys. The most common material is copper.

In this embodiment, no matter the basal pattern (70, 71 and 72) is bar or other shapes is similar to the conductive pattern (60, 61 and 62). The basal pattern (70, 71 and 72) is located vertically below the conductive pattern (60, 61 and 62), and the projection of the conductive pattern (60, 61, and 62) on the bottom layer is comprised by the basal pattern (70, 71 and 72), whereby thermal expansion between the basal pattern (70, 71 and 72) side and the conductive pattern (60, 61 and 62) side is balanced, protecting the PCB 10 from thermal deformation and providing sufficient EMI shielding. Furthermore, by applying materials of similar thermal expansion coefficients to form the conductive pattern (60, 61 and 62) and basal pattern (70, 71 and 72), or by applying a material with a thermal expansion coefficient slightly less than the conductive pattern (60, 61 and 62) to form the basal pattern (70, 71 and 72), the invention can be accomplished.

The foregoing description has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A printed circuit board, comprising:
a patterned bottom layer;
at least one core layer and one insulating layer laminated on the bottom layer; and
a patterned conductive layer correspondingly formed over the patterned bottom layer, with the core layer and the insulating layer disposed therebetween,
wherein the patterned conductive layer has a pattern similar to that of the patterned bottom layer, and the projection of the patterned conductive layer onto the patterned bottom layer within the pattern of the patterned bottom layer.

2. The printed circuit board as claimed in claim 1 further comprises at least one conductive layer between the core layer and the insulating layer.

3. The printed circuit board as claimed in claim 1, wherein the bottom layer and the conductive layer compose conductive materials with the same or similar thermal expansion coefficients.

4. The printed circuit board as claimed in claim 3, wherein the conductive materials are metals.

5. The printed circuit board as claimed in claim 4, wherein the metals am Cu, Au, Ag, Fe, W, Al, Ni, Co or their alloys.

6. The printed circuit board as claimed in claim 1, wherein the patterned bottom layer and the patterned conductive layer have the same pattern.

7. The printed circuit board as claimed in claim 1, wherein the insulating layer is a resin layer.

8. The printed circuit board as claimed in claim 1, further comprising solder mask on the patterned conductive layer.

9. The printed circuit board as claimed in claim 1, wherein the thermal expansion coefficient of the bottom layer is less or equal to that of the conductive layer.

10. A printed circuit board, comprising:
a patterned bottom layer,
a core structure sandwiched by a first and a second insulating layers on the bottom layer; and
a patterned conductive layer correspondingly formed over the patterned bottom layer, with the core layer and the insulating layer disposed therebetween,
wherein the patterned bottom layer has a pattern substantially the same as the patterned conductive layer.

11. The printed circuit board as claimed in claim 10, wherein the core structure comprises a core layer and a first and second conductive layers.

12. The printed circuit board as claimed in claim 10, wherein the bottom layer and the conductive layer comprise conductive materials with the same or similar thermal expansion coefficients.

13. The printed circuit board as claimed in claim 12, wherein the conductive materials are metal.

14. The printed circuit board as claimed in claim 13, wherein the meals are Cu, Au, Ag, Fe, W, Al, Ni, Co or their alloys.

15. The printed circuit board as claimed in claim 10, wherein the bottom layer and the correspondingly patterned conductive layer have the same pattern.

16. The printed circuit board as claimed in claim 10, wherein the first and the second insulating layers are resin layers.

17. The printed circuit board as claimed in claim 10, further comprising solder mask on the patterned conductive layer.

18. The printed circuit board as claimed in claim 10, wherein the thermal expansion coefficient of the bottom layer is less or equal to that of the conductive layer.

19. A printed circuit board, comprising:
a patterned bottom layer;
at least one core layer and one insulating layer laminated on the bottom layer; and
a patterned conductive layer correspondingly formed over the patterned bottom layer, with the core layer and the insulating layer disposed there between,
wherein the patterned bottom layer has a pattern substantially the same as the patterned conductive layer.
